(19) United States
(12) Patent Application Publication
(10) Pub. No.: US 2006/0098817 A1
(43) Pub. Date: May 11, 2006

(54) Method of and apparatus for encoding a signal in a hashing primitive

(76) Inventor: Sean O'Neil, Fortitude Valley (AU)

Correspondence Address: HOFFMAN, WASSON & GITLER, P.C.;CRYSTAL CENTER 2, SUITE 522, 2461 SOUTH CLARK STREET, ARLINGTON, VA, 22202, US

(21) Appl. No.: 11/267,189

(22) Filed: Nov. 7, 2005

Related U.S. Application Data
(63) Continuation of application No. PCT/IB05/01475, filed on May 10, 2005.

(30) Foreign Application Priority Data
Nov. 5, 2004 (AU) 2004906364
Jan. 10, 2005 (AU) 2005900087

(51) Int. Cl. H04L 9/30

(52) U.S. Cl. 380/30

(57) ABSTRACT

A process (100, 200, 300) receives at least one block of plaintext material (161, 163, 271, 273) and initializes intermediate text (150, 250). The intermediate text (150, 250) is larger than 58 octets. An updating process includes the invocation of at least one round function (171, 172, 282, 282). Each round function (171, 172, 282, 282) receives inputs which are one input selected from the intermediate text (150, 250), at least two inputs selected from the intermediate text (150, 250), so that each pair of the at least two inputs selected from the intermediate text (150, 250) is separated by at least one bit of intermediate text (150, 250). Each of the inputs is at least 2 bits in length. Each round function (171, 172, 282, 282) generates at least one output that updates at least two bits of the intermediate text (150, 250). The sum of the length of the inputs received by the round function (171, 172, 282, 282) from the intermediate text (150, 250) is less than the length of the intermediate text (150, 250) in bits minus eight times the length of the sum of the output bits of the round function. This is done in such a way that in at least one invocation of least one round function (171, 172, 282, 282) that round function additionally receives one input which comprises at least two bits of plaintext material (161, 163, 271, 273). The process also has an output function which releases a set of bits from the intermediate text (150, 250).

The present application claims priority from the following applications:

Australian provisional application 2004906364 filed on 5 Nov. 2004;

Australian provisional application 2005900087 filed on 10 Jan. 2005; and

International Patent Application PCT/IB2005/001475 filed on 10 May 2005, the contents of each of which is incorporated herein by reference.

The present application is also related to our co-pending applications:

International Patent Application PCT/IB2005/001487 filed on 10 May 2005;

International Patent Application PCT/IB2005/001499 filed on 10 May 2005;

Australian provisional patent application number 2005902149 filed on 29 Apr. 2005; and

Australian provisional patent applications number 2005902150 filed on 29 Apr. 2005,

the contents of each of which is incorporated herein by reference.

### FIELD OF THE INVENTION

The present invention relates to cryptographic hashing primitives.

### BACKGROUND OF THE INVENTION

Throughout this specification, including the claims:

the term ‘secret key material’ refers to material that comprises of at least one secret key or material derived from that at least one secret key. We use the term ‘key material’ synonymously with the term ‘secret key material’;

we use the term ‘plaintext material’ to refer to material that consists of at least one block of plaintext or material directly derived from that at least one block of plaintext; and

when we refer to blocks of data, key or hash bits, it is to be understood that they are of arbitrary size, not necessarily identical in size, and depend on the function receiving input or generating output; we use the term ‘balanced constant’ to refer to constants chosen as balanced log(N)-bit Boolean functions (consisting of 50% binary zero digits) with high non-linearity and that satisfy other cryptographic properties including but not limited to those as described in the masters thesis ‘On the Design of S-Boxes’ by A. F. Webster and S. E. Tavares, Department of Electrical Engineering, Queen's University, Kingston, Ont. Canada, published in LNCS no. 218, pp. 523-534 (1986).

In the art, a linear cryptographic function ƒ is understood to be a function of any given number of inputs and any given number of outputs such that the relationship between every bit of output and every bit of input is a polynomial of a degree not higher than 1.

A typical linear cryptographic function is a set of bits each of which is a XOR of a number of input bits. All linear cryptographic functions are reversible. There are no irreversible linear cryptographic functions. (An illustration of the sense that the term ‘polynomial’ has in the present art is in the analysis of linear feedback shift registers which is set out at pages 372 to 379 of the book Applied Cryptography: Protocols, Algorithms, and Source Code in C by Bruce Schneier, second edition, 1996.)

A cryptographic function is called reversible regarding a given input if the computational cost of finding the value of that input knowing the output and all other inputs is comparable with the computational cost of calculation of the cryptographic function itself. Addition modulo 2ⁿ, multiplication modulo 2ⁿ and multiplicative inverse modulo 2ⁿ are typical reversible nonlinear cryptographic functions.

A cryptographic function is called irreversible regarding a given input if the computational cost of finding the value of that input knowing the output and all other inputs is either computationally infeasible or extremely high comparing with the computational cost of calculation of the cryptographic function itself. y=x<<<x (x rotated left by x bit) is a typical example of an irreversible nonlinear cryptographic function.

The reversibility of a nonlinear cryptographic function regarding any of its inputs is determined individually for each input. Any given nonlinear cryptographic function may be reversible regarding one input and irreversible regarding another or it can be either reversible or irreversible regarding all its inputs.

For example, a block cipher is a reversible nonlinear cryptographic function regarding its plaintext input, but it is irreversible regarding its key, and a keyed cryptographic hash is irreversible regarding its inputs, data and key.

A linear combination of nonlinear cryptographic functions is also a nonlinear cryptographic function. A nonlinear cryptographic function of a linear combination of its inputs is also a nonlinear cryptographic function. Both these cases are referred to as ‘a nonlinear cryptographic function’ in this specification and are marked according to their reversibility regarding the current block as one of the inputs.

If a nonlinear cryptographic function is reversible regarding one of its inputs x, then a reversible linear or nonlinear combination of that input x or that function's output with any other input is also a nonlinear cryptographic function reversible regarding that input x.

If a nonlinear cryptographic function is irreversible regarding one of its inputs x, then a combination of one or more of its inputs and/or its output with any other cryptographic function, linear or nonlinear, reversible or irreversible is also irreversible regarding that input x.

Cryptographic encryption operations, in general, receive plaintext and generate intermediate text. That intermediate text is received by further cryptographic encryption operations which update a portion of the intermediate text in a nonlinear fashion. After yet further encryption operations are completed, the final intermediate text is released as ciphertext.

A cryptographic encryption operation that generates intermediate text, in general, is referred to as a round function. Round functions may in turn invoke sub-round functions.

The same terminology of intermediate text and round function is also used where the overall cryptographic operation is a decryption process.

Counters are used in cryptographic applications to ensure guaranteed minimum period loops. The simplest such example is achieved by incrementing an n-bit counter modulo n. Counters may be linear or nonlinear.

The following papers surveying cryptographic hashing primitives and are incorporated herein by reference:
B. Preneel, ‘Analysis and Design of Cryptographic Hash Functions’, PhD. Thesis, Catholic University of Leuven 1993.
B. Preneel, R. Govaerts, and J. Vandewalle, “Hash functions based on block ciphers: A synthetic approach.” in Advances in Cryptology—Crypto'93 (D. Stinson, ed.), no. 773 in Lecture Notes in Computer Science, pp. 368-378, Springer-Verlag, 1994.
S. Bakhtiari and R. Safavi-Naini and J. Pieprzyk, ‘Cryptographic Hash Functions: A Survey’, Technical Report 95-09, Department of Computer Science, University of Wollongong, July 1995.
B. Van Rompay, ‘Analysis and Design of Cryptographic Hash Functions, Mac Algorithms and Block Cipher,” PhD. Thesis, Catholic University of Leuven, 2004.
S. Lucks, ‘Design Principles for Iterated Hash Functions’, Cryptology ePrint Archive, report 2004/253.

There are a few general classes of operation for cryptographic hash primitives:

parallel aggregation
Merkle-tree
parallel FFT-hashing

iterated hashing
Merkle-Damgåan hash
   MDx Family (Haval, SHAx, RIPEMD-x)
   That use substitution-boxes (Snefru, Whirlpool)
Davies-Meye hash
   Block-cipher mode of hashing such that the user message is supplied as irreversible input and the feedback supplied as reversible input.
hash functions as described in our above-referenced co-pending Australian provisional patent application number 2005902149.
hash functions as described in our above-referenced copending Australian provisional patent application number 2005902150.

Cryptographic hashing primitives are known to include techniques based upon:

standard block ciphers techniques.
source heavy Feistel networks receiving n−1 blocks of n blocks of intermediate text as input.
standardized block ciphers
   . . . and such that the output of a single block cipher invocation is a cryptographically secure operation.

modular arithmetic
factorization problem
discrete logarithm problem

knapsack problem

algebraic matrices

cellular automaton

We restrict our survey, but not the scope of the invention, to cryptographic hash primitives based on iterated hashing constructions utilizing block cipher like techniques. There are multiple message expansion strategies employed by dedicated hash functions including:

no message expansion, hashing intermediate text and output compression

message expansion via duplication and nonlinear compression

linear message expansion and nonlinear compression

nonlinear message expansion and nonlinear compression

techniques as described in our copending applications on hashing primitives.

The high-level process employed to implement a large variety of cryptographic hash processes share significant similarities with the high-level process employed to implement many block ciphers.

Cryptographic hashing primitives, in general, initialize an intermediate state with a fixed balanced constant. Round functions receive plaintext or material derived from plaintext, and also receive intermediate text. The round functions update the intermediate text. In the general case, the intermediate text is significantly smaller than the plaintext message to be hashed resulting in the plaintext message compressing into the intermediate text. After the complete plaintext message supplied by the user has been compressed into the intermediate text, a derivative of the intermediate text is released as a hash image.

It is to be appreciated that compression functions are generally understood to receive significantly more input to their round functions than intermediate text released as output before the intermediate text is reinitialized. Compression functions used in hash functions receive material derived from the entire plaintext before releasing part of its intermediate text as output, requiring the intermediate text to be completely reset before the hash function receives a new plaintext input to hash.

It is to be appreciated that expansion functions are generally understood to release significantly larger amount of intermediate text in comparison to the material derived from plaintext received by the function. Expansion functions in cryptographic hash primitives are known to release intermediate text while receiving plaintext and after receiving plaintext.

A more detailed review of the most relevant stream ciphers with intermediate text updated with a nonlinear round function follows.

The paper by R. Merkle, ‘A Fast Software One-Way Hash Function’, Journal of Cryptology, Vol. 3, No. 1, pp. 43-59, 1990 introduces the Snefru hash function. Snefru version 1.0 employs a nonlinear target heavy Feistel network that iterates sequentially over the blocks of the intermediate text. Only eight bits of output from the previous round function is supplied as input to an 8×32-bit substitution-box and the thirty-two bit output is linearly combined with the cyclic neighbouring blocks.

Snefru version 2.0 employs a similar nonlinear target heavy Feistel network that iterates sequentially over the blocks of the intermediate text. The round function is improved to incorporate rotation operations.

The MDx hashing family includes the MD5, SHA-1 and SHA-256 primitives.

R. Rivest, ‘The MD5 Message-Digest Algorithm’, published as RFC 1321, Internet Engineering Task Force in April 1992.

The SHA-1 and SHA-256 specifications are disclosed in ‘Secure Hash Standard’, U.S. Federal Information Processing Standard 180-2, August 2002.

Compression functions as found in the MD5, SHA-1 ciphers employ the use of linear message expansion and a compression module with an intermediate text of 128, and 160 bits in length respectively. The compression module's round functions receive as input, the entire user intermediate text as input without being reinitialized. The MD5 and SHA-1 hashing primitives release their complete intermediate texts as the hash.

The SHA-256 has a 512-bit expansion module (called a message-digest) and two independent 256-bit compression modules (called the compression and intermediate hash functions), both 256 bits in length. The plaintext is supplied as input into the expansion function, the output of the expansion function is supplied to the first compression function, and the output of the first compression function supplied as input to the second compression function. The expansion function is reset for each 512 bits of plaintext received after expanding each 512 bit segment of plaintext by four times. The final hash image generated by SHA-256 after receiving the entire plaintext is achieved by releasing the full intermediate text of the second compression function.

It is to be appreciated that the expansion function as found in SHA-256 is not in itself intended to be a secure cryptographic construction. Additionally it is to be appreciated that resetting the intermediate text of the expansion function every 512 bits of user data, allows an attacker to trivially select every possible 512-bit message as the output of the expansion function supplied as input into the first compression function.

The problem of efficiently hashing material derived from plaintext into a large intermediate text, be it for the purpose of compression or expansion is most closely related to our above-referenced co-pending International Patent Application number PCT/IB2005/001487 entitled Process of and Apparatus for Encoding a Signal, which is related to the efficient encryption of a variable length block cipher.

### SUMMARY OF THE INVENTION

The present invention accordingly provides a process which receives at least one block of plaintext material. The process comprises an initialization process including the initialization of intermediate text, the intermediate text being larger than 58 octets. An updating process comprises the invocation of at least one round function, each round function receiving inputs comprising one input selected from the intermediate text at least two inputs selected from the intermediate text, so that each pair of the at least two inputs selected from the intermediate text is separated by at least one bit of intermediate text. Each of the inputs is at least 2 bits in length. At least one output is generated that updates the intermediate text and at least two bits of the intermediate text are updated. The sum of the length of the inputs received by the round function from the intermediate text is less than the length of the intermediate text in bits minus eight times the length of the sum of the output bits of the round function. In at least one invocation of least one round function, that round function additionally receives one input which comprises at least two bits of plaintext material. An output function which releases a set of bits from the intermediate text.

In another aspect, an apparatus receives at least one block of plaintext material. The apparatus comprises an initialization module which initializes intermediate text, the intermediate text being larger than 58 octets. An updating module invokes at least one round function, each round function receives inputs comprising one input selected from the intermediate text at least two inputs selected from the intermediate text. Each pair of the at least two inputs selected from the intermediate text is separated by at least one bit of intermediate text. Each of the inputs is at least 2 bits in length generating at least one output that updates the intermediate text; where at least two bits of the intermediate text is updated. The sum of the length of the inputs received by the round function from the intermediate text is less than the length of the intermediate text in bits minus eight times the length of the sum of the output bits of the round function. In at least one invocation of at least one round function that round function additionally receives one input which comprises at least two bits of plaintext material. An output module releases a set of bits from the intermediate text.

### BRIEF DESCRIPTION OF THE DRAWINGS

In the drawings:

FIGS. 1 and 2 illustrate a process according to one preferred embodiment of the present invention; and

FIGS. 3 and 4 illustrate another two preferred embodiments of the present invention.

### DESCRIPTIONS OF PREFERRED EMBODIMENTS OF THE INVENTION

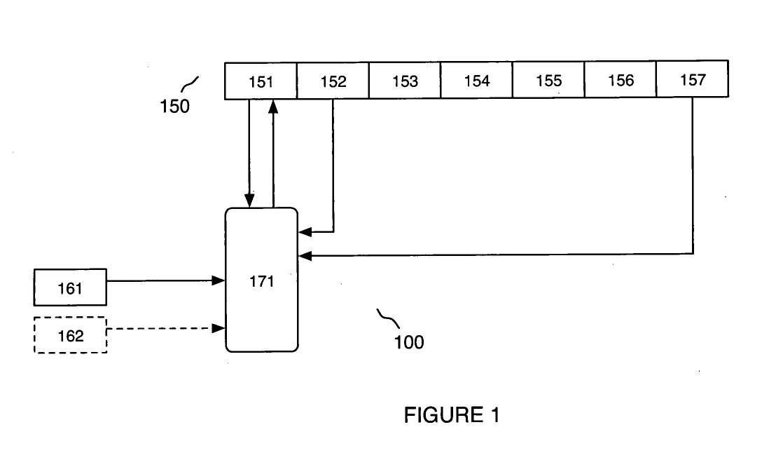

In FIG. 1, reference number 150 indicates seven blocks 151 to 157 of intermediate text. The intermediate text 150 is of variable length and is illustrated as seven blocks in length. The intermediate text 150 is taken as a contiguous sequence of blocks during coding operations. Block 161 is at least zero blocks of plaintext material to be hashed. Block 162 is zero or more blocks of irreversible input. Round function invocation 171 receives three consecutive blocks 157, 151 and 152 of inputs from the intermediate text 150. Round function invocation 171 releases as output material updating block 151.

It is to be appreciated that at least one round function invocation receives plaintext material to be hashed into the intermediate text 150 before the hashing primitive as a whole releases a hash image derived from the intermediate text 150.

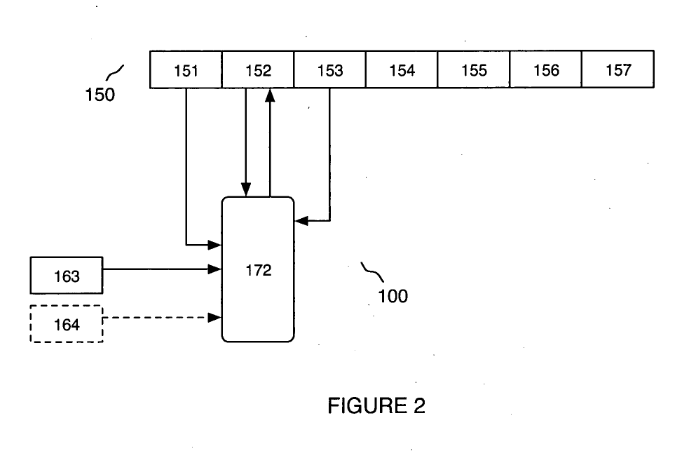

FIG. 2 illustrates the second step of the process of FIG. 1.

Round function invocation 172 receives three consecutive blocks 151, 152 and 153 of input from the intermediate text 150. Block 163 is at least zero blocks of plaintext to be hashed Block 164 is zero or more blocks of irreversible input. Round function invocation 172 releases as output material updating block 152. It is preferred that the round function of invocation 172 is the same as the round function of invocation 171 but in FIG. 2 it is given the reference number 172 for ease of discussion.

The round function invocation 172 takes as input the output of the previous round function invocation 171, one of the unmodified inputs 152 of the previous round function and one block of input 153 not received as input to the previous round function invocation 171. The output of round function invocation 172 updates the block 152 of input of the previous round function invocation 171.

The hashing of the intermediate text is illustrated by the transition from FIG. 1 to FIG. 2.

It is to be appreciated that for each round function invocation, after the first round function invocation, the current round function invocation takes as input the output of the previous round function invocation, ensuring the most rapid avalanche and replaces one of the unmodified inputs of the previous round function, ensuring part of the information used to calculate the previous output is modified. This modification of the irreversible input to the previous round creates a strict chronological dependency in the forwards and backwards direction that improves the security of the construction.

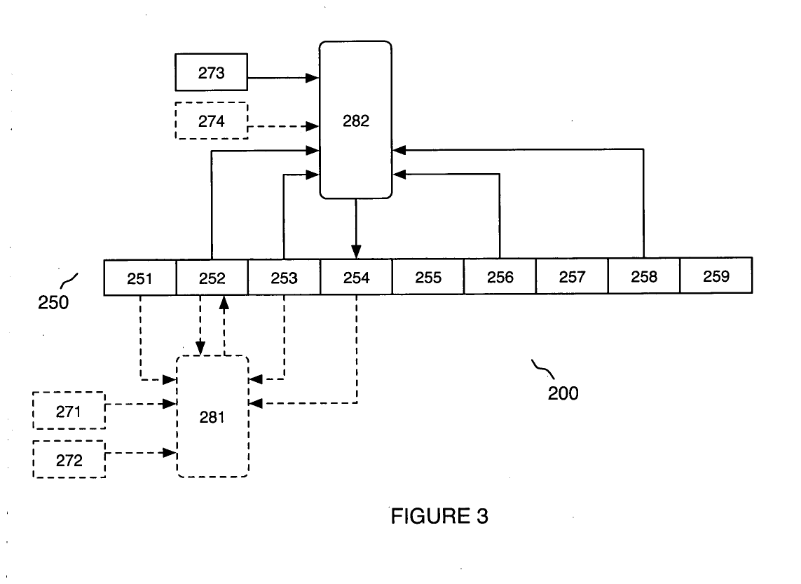

FIG. 3 illustrates another preferred embodiment of the present invention.

Reference number 250 indicates nine blocks 251 to 259 of intermediate text. The intermediate text 250 is of variable length and is illustrated as nine blocks in length. The intermediate text 250 is taken as a contiguous sequence of blocks during coding operations. Block 271 is zero or more blocks of plaintext material. Block 272 is zero or more blocks of irreversible input. Block 273 is zero or more blocks of plaintext material. Block 274 is zero or more blocks of irreversible input.

The previous round function invocation 281 takes as 4 blocks of input 251, 252, 253 and 254 from the intermediate text and at least zero blocks 271 of plaintext material. The round function invocation 281 releases as output 252.

The round function invocation 282 takes as input the output of the previous round function invocation 281, one of the unmodified inputs 253 of the previous round function invocation, two blocks of input 256 and 258 not received as input to the previous round function invocation. The round function invocation 282 also receives at least zero blocks 273 of plaintext material. The output of round function invocation 281 updates a block 254 of input of the previous round function invocation. It is preferred that round function of invocation 281 is the same as the round function of invocation 282 for ease of discussion.

The process of hashing plaintext material-into the intermediate text involves an initialization process which prepares the intermediate text, followed by a process of updating the intermediate text. The process of updating the intermediate text uses a round-function. In addition an output function generates output derived from the intermediate text. The updating process may receive as much plaintext material as required by the user.

In a preferred embodiment the intermediate text is reinitialized only when the larger cipher of which it is a part is also reinitialized.

In a preferred variation of the present invention the intermediate text is initialized with a secret key.

In a preferred variation of the present invention the intermediate text is initialized with a constant key and the secret key is supplied as input to at least one round function.

In a preferred variation of the current invention the round function is supplied with counter material for the purpose of ensuring minimum guaranteed period lengths.

In a preferred embodiment of the current invention one plaintext block is supplied as input to at least every second consecutive round function invocation.

In a preferred embodiment of the current invention one plaintext block is supplied as input to at least two consecutive round function invocations.

In a preferred embodiment of the current invention the entire user plaintext message is hashed, and then the entire user plaintext message is further supplied as input to be hashed at least one more time.

In a preferred variation of the current invention the output of the round function updating the intermediate text is supplied as input to a nonlinear and filter function and the generated output is released to another process. In a preferred variation of the current invention the set of inputs supplied to the round function invocation updating the intermediate text is also supplied as input to a filter function and the generated output is released to another process. In a preferred variation the filter function is a nonlinear filter function. In a preferred variation the filter function is a keyed nonliner filter function. In a preferred variation the filter function is a block cipher having a process with multiple rounds.

In a preferred variation of the current invention a unique selection of inputs is supplied as input to a filter function and the generated output is released to another process, such that the intermediate text supplied to the filter function is different to the intermediate text supplied to the round function invocation updating the intermediate text.

In a preferred variation of the current invention the filter function receives both the output of the round function and material selected from the intermediate text not supplied as input.

in a preferred variation of the current invention more than one block of intermediate text is updated before any material is released as output.

In a preferred variation there are two unique round functions updating the intermediate text, the first used during the initialization process and the other round function used during the updating process.

In a preferred variation the output process has a unique round function.

In a preferred variation of the current invention the round function is a block cipher.

In a preferred variation of the current described embodiment the block cipher has irreversible inputs that are at least twice the length of the reversible input, such as a 128-bit block cipher that employs a 256-bit key.

In a preferred variation of the currently described embodiment, the block cipher has fewer rounds than is required for the output of the block cipher invocation to be a cryptographically secure on its own right.

In a preferred variation of the currently describe embodiment the block cipher is a tweakable block cipher such that the secret key and ‘tweakable’ input is adapted to receive intermediate text.

In a preferred embodiment the blocks are thirty-two bits in length executing on a 32-bit processor with 32-bit wide operations efficient on the 32-bit processor. In a preferred embodiment the blocks are 64-bits in length executing on a 64-bit processor with 64-bit wide operations efficient on the 64-bit processor.

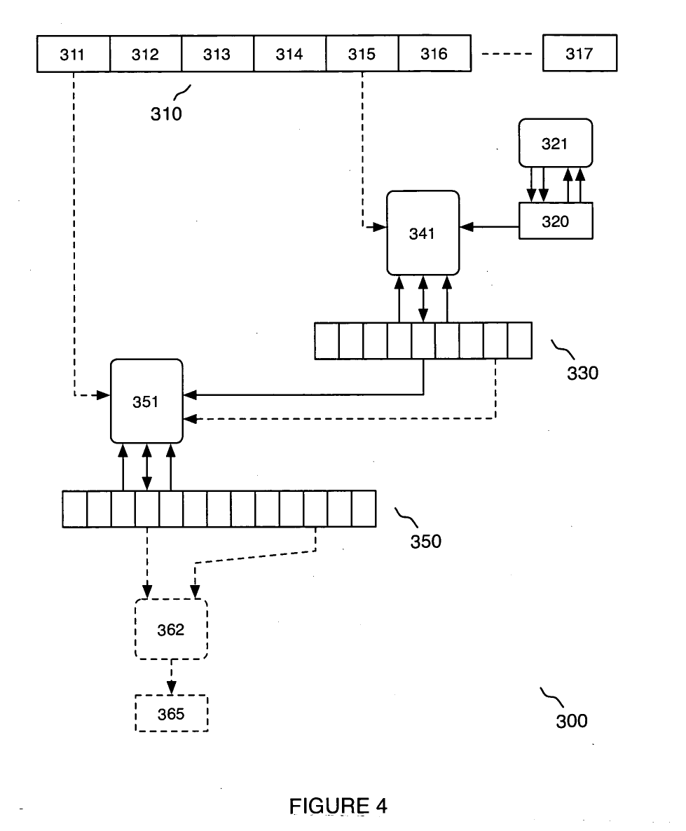

FIG. 4 illustrates an exemplary hash function according to a preferred embodiment of the current invention.

The reference number 310 indicates a key-padded message, which is to be hashed. The key-padded message 310 is formatted according to the methods disclosed for FIG. 5 of our copending Australian provisional patent application number 2005902149 entitled Process of and Apparatus for Hashing. Seven blocks of the message 310 are illustrated. Function 321 is a counter for the purpose of ensuring guaranteed minimum period lengths updating its state 320.

The reference number 330 indicates nine blocks of a first intermediate text. The intermediate text 330 is taken as a contiguous sequence of blocks during coding operations. Round function invocation 341 receives as irreversible input the output of the immediately previous round function invocation updating the intermediate text 330, one block of irreversible input that is updated by the output of the current round function invocation, and one block of irreversible input that is not supplied as input to the previous round function invocation. Round function invocation 341 receives counter material. Round function invocation 341 optionally receives input from the message 310.

The reference number 350 indicates thirteen blocks of a second intermediate text. The intermediate text 350 is taken as a contiguous sequence of blocks during coding operations.

Round function invocation 351 receives as irreversible input the output of the immediately previous round function invocation updating the intermediate text 350, one block of irreversible input that is updated by the output of the current round function invocation, and one block of irreversible input that is not supplied as input to the previous round invocation. Round function invocation 351 receives as irreversible input the output of the round function invocation 341. Round function invocation 351 receives as irreversible input at least zero blocks of the first intermediate text 330 not supplied as input or updated by the round function invocation 341.

Round function invocation 361 receives as irreversible input the output of the immediately previous round function invocation updating the intermediate text 350, one block of irreversible input that is updated by the output of the current round function invocation, and one block of irreversible input that is not supplied as input to the previous round invocation.

Nonlinear filter function invocation 362 receives as irreversible input the output of the round function invocation 361 and a block of intermediate text 350 not supplied as input or updated by the output of the round function 361 generating a block of output 365.

The method of operation of 300 includes a first initialization process that initializes 320, 330 and 350 according to any of the techniques described in our copending patent application.

After process 300 is initialized, the keyed user message 310 is hashed into 330 and 350. The round functions 341 and 342 receive the blocks 311 and 315 respectively. The round function 341 updating 330 is performing a message expansion function, receiving one block of plaintext and releasing two blocks of encoded per round function invocation. The round function 351 updating 350 is performing a message compression function, receiving two blocks of input derived from plaintext and not releasing output to another process.

After the keyed user message has been hashed into 330 and 350, the round function invocations 341 and 351 no longer receive input from keyed user message 310. The intermediate text 330 and 350 is sealed by performing five complete passes ensuring 341 and 351 update each block of intermediate text 330 and 350 at least five times. The round function invocation 341 updating intermediate text 330 is now performing an expansion function (acting as a stream cipher). The round function invocation 351 updating the intermediate text 350 is now performing a hash function.

After intermediate text 330 and 350 has been sealed, the hash function generates a hash image. One block of hash 365 is generated for every block of intermediate text 330 and 350 updated by performing a nonlinear filter 362 on the output of round function invocation 351 and selecting a block of intermediate text 350 not supplied as input or the updated by the output of round function 351. The round function invocation 351updating the intermediate text 350 is now performing an expansion function (acting as a stream cipher) enabling a hash-image of arbitrary length to be generated.

It is readily appreciated that several optimizations are possible when implementing dedicated round functions and filter functions. For instance the round function updating the intermediate text and nonlinear filter may be optimized to share common logic.

Although we have described detailed embodiments of the invention, with a number of variations, which incorporate the teachings of the present invention, the skilled reader of this specification can readily devise other embodiments and applications of the present invention that utilize these teachings.

1. A process which receives at least one block of plaintext material, the process comprising:
an initialization process comprising the initialization of intermediate text the intermediate text being larger than 58 octets;
an updating process comprising:
the invocation of at least one round function, each round function:
receiving inputs comprising:
one input selected from the intermediate text;
at least two inputs selected from the intermediate text, so that each pair of the at least two inputs selected from the intermediate text is separated by at least one bit of intermediate text; and
each of the inputs is at least 2 bits in length
generating at least one output that updates the intermediate text;
where at least two bits of the intermediate text is updated;
and in which:
the sum of the length of the inputs received by the round function from the intermediate text is less than the length of the intermediate text in bits minus eight times the length of the sum of the output bits of the round function; and
and such that in at least one invocation of least one round function:
that round function additionally receives one input which comprises at least two bits of plaintext material; and
an output function which releases a set of bits from the intermediate text.

2. A process as claimed in claim 1, in which at least a portion of at least one of the inputs to at least one round function is selected as the output of the selected round function's immediately preceding round function invocation.

3. A process as claimed in claim 1, in which at least a portion of at least one of the inputs to a round function invocation is selected as one of the inputs to the previous round function invocation that was not updated by the output of the previous round function.

4. A process as claimed in claim 1, in which at least a portion of at least one of the inputs to the an invocation of at least one round function is selected from a region of intermediate text which:
was not selected as input to the selected round function's immediately preceding round function invocation; and
is not material which was updated by the output of the selected round function invocation's immediately preceding round function invocation.

5. A process as claimed in claim 1, in which at least a portion of a region of intermediate text which was supplied as input to an invocation of a round function is updated by the output of that invocation of the round function.

6. A process as claimed in claim 1, in which the at least a portion of a region of intermediate text that is supplied to an invocation of a round function is supplied as irreversible input and the output of that invocation of the round function invocation updates a portion of a region of intermediate text that was input as reversible input to the immediately previous round function invocation of the selected round function invocation.

7. A process as claimed in claim 1, in which the hashing of a user message is cancelled, resulting in the intermediate text being reinitialized.

8. A process as claimed in claim in 7, in which during the uncancelled encoding of a user message, the round function invocations receive the entire length of the plaintext material to be hashed without reinitializing the intermediate text that is being updated by the round function invocations.

9. A process as claimed in claim 1, in which each time the intermediate text is updated, the length of the output released by the output function is less than the length of the intermediate text updated.

10. Apparatus which receives at least one block of plaintext material, the apparatus comprising:
an initialization module which initializes intermediate text, the intermediate text being larger than 58 octets;
an updating module which:
invokes at least one round function, each round function:
receiving inputs comprising:
one input selected from the intermediate text;
at least two inputs selected from the intermediate text, so that each pair of the at least two inputs selected from the intermediate text is separated by at least one bit of intermediate text; and
each of the inputs is at least 2 bits in length
generating at least one output that updates the intermediate text;
where at least two bits of the intermediate text is updated;
and in which:
the sum of the length of the inputs received by the round function from the intermediate text is less than the length of the intermediate text in bits minus eight times the length of the sum of the output bits of the round function; and
and such that in at least one invocation of least one round function:
that round function additionally receives one input which comprises at least two bits of plaintext material; and
an output module which releases a set of bits from the intermediate text.

11. Apparatus as claimed in claim 10, in which at least a portion of at least one of the inputs to at least one round function is selected as the output of the selected round function's immediately preceding round function invocation.

12. Apparatus as claimed in claim 10, in which at least a portion of at least one of the inputs to a round function invocation is selected as one of the inputs to the previous round function invocation that was not updated by the output of the previous round function.

13. Apparatus as claimed claim 10, in which at least a portion of at least one of the inputs to the an invocation of at least one round function is selected from a region of intermediate text which:
was not selected as input to the selected round function's immediately preceding round function invocation; and
is not material which was updated by the output of the selected round function invocation's immediately preceding round function invocation.

14. Apparatus as claimed in claim 10, in which at least a portion of a region of intermediate text was supplied as input to an invocation of a round function is updated by the output of that invocation of the round function.

15. Apparatus as claimed in claim 10, in which the at least a portion of a region of intermediate text that is supplied to an invocation of a round function is supplied as irreversible input and the output of that invocation of the round function invocation updates a portion of a region of intermediate text that was input as reversible input to the immediately previous round function invocation of the selected round function invocation.

16. Apparatus as claimed in claim 1, in which the hashing of a user message is cancelled, resulting in the intermediate text being reinitialized.

17. Apparatus as claimed in claim in 16, in which during the un-cancelled encoding of a user message, the round function invocations receive the entire length of the plaintext material to be hashed without reinitializing the intermediate text that is being updated by the round function invocations.

18. Apparatus as claimed in claim 10, in which each time the intermediate text is updated, the length of the output released by the output function is less than the length of the intermediate text updated.
